(19) United States
(12) Patent Application Publication
(10) Pub. No.: US 2004/0044552 A1
(43) Pub. Date: Mar. 4, 2004

(54) Method and system for generating performance data

(76) Inventor: Lee Marwood, Kingston-Upon-Thames (GB)

Correspondence Address: James R Yee, Howard & Howard, The Pinehurst Office Center, 39400 Woodvard Avenue Suite 101, Bloomfield Hills, MI, 48304-5151, US

(21) Appl. No.: 10/362,856

(22) PCT Filed: Aug. 31, 2001
(86) PCT No.: PCT/GB01/03930

(51) Int. Cl. G06F 17/60

(52) U.S. Cl. 705/7

(57) ABSTRACT

According to one aspect of the present invention there is provided a system for measuring the financial and operational effectiveness of a multi-parameter entity, such as a company, the system comprising: input means for collecting multi-parameter input data in a predetermined questionnaire format describing the operation and function of the entity; wherein the input means is arranged to collect entity generic data for diverse entity comparisons, and entity specific data obtained in a predetermined set of categories for similar entity comparisons; a database of averaged multi-parameter input data comprising averaged entity generic data and averaged entity specific data; and a comparison means arranged to compare the entity generic data with the stored averaged entity generic data to determine the condition of the entity relative to a diverse range of entities, and to compare the entity specific data with the stored averaged entity specific data to determine the condition of the entity relative to a subset of similar entities.

### FIELD OF THE INVENTION

The present invention relates to a method and system for generating performance data and, more particularly, though not exclusively, to a method and system of analysing multi-dimensional company business data including point of sale data and generating performance data in the form of an analytical report. The present invention has particular application to highly complex industries, such as the catering industry, where the number of variables in the company's operation is so high that it is impossible for an analyst to determine accurately the performance of the company in consideration of all of the variables, such as the financial and operational effectiveness of the organisation without aid of computing power. The present invention can also be used to analyse the performance of a company's process for tendering for contracts.

### BACKGROUND OF THE INVENTION

The analysis of company performance is a well established business practice amongst accountants, investors, company analysts and company management itself. This analysis has been very heavily based on the financials of the company and has often been looked at in terms of a handful of factors, for. example overall profit, work in progress, debtors book, creditors book, order book, etc.

A detailed comparison of how well a company is performing is usually restricted to a comparison of present performance with that company's past performance (last year's accounts) as this enables the best like-for-like comparison to be made. It is not usually possible to compare different companies in such a detailed analysis, even if they are in the same sector, because of two reasons. Firstly, different companies have different ways of expressing the detailed categories of business in which they operate. Secondly, usually two companies never have exactly the same detailed profile such that any comparison becomes inaccurate. However, as mentioned before, some broad generic financial variables such as the profitability of a company can be readily compared with other companies to give a comparative view of the company's performance albeit only as a general overview.

The above-mentioned problems become particularly acute for complex businesses where there are hundreds if not thousands of variables to consider. One such type of business is the catering industry where it is very important to understand how and where in a multi-dimensional process, there are greater opportunities for profit to be made. This is because a small saving in one factor can have major implications on the profit of the company due to the volumes often involved. The way in which the catering industry in the UK has changed is now described.

Up to about the 1970's, staff catering (cost sector) was perceived as a labour on-cost to a business either for staff retention or by Union pressure. In the 1970's there was a major change by businesses to outsource the catering finction to professional catering contractors. During the 1980's, businesses became more cost conscience and accountable, therefore a need arose to check and maintain a ‘value for money’ service. The contractors became under pressure to deliver a ‘value for money’ service and to be able to prove their earnings were reasonable and competitive. Tendering, particularly in the public sector, became the norm and the larger, multi-site businesses found tendering to be usefuil as a start point to measure contractor performance. Accounting and performance measurement procedures were devised by the businesses without detailed catering knowledge and the caterers continued to account for their performance on basic schemes devised in the 1940's and 1950's. The 1990's brought further moves to cost reduction. Many cost sector catering service providers were forced to adopt a retail (High Street) attitude towards commodity selling prices and the management of overhead costs. Towards the latter half of the decade, a fashion to nil cost and in certain circumstances the caterer paid a concession to the host client.

In the 1980's, a group of catering controllers, i.e. professional caterers managing multi-million pound catering budgets within blue chip businesses, grouped together to devise a mechanism to measure best value performance. The style and complexity of the businesses varied so common ground to compare the catering operations was never found and the group disbanded. The exercise did, however, produce some broad bands of percentage relationships, e.g. labour and overhead costs to revenue, gross profit, full time equivalent labour to customers served.

More recently another group of catering controllers representing major UK and International companies have attempted to compare their business performance within the group by way of a survey. Whilst these caterers all provided staff and retail catering for the organizations, the types of catering and the operation of the catering differed significantly, for example including a mix of in-house managed catering and contracted out catering services at different locations spread around the UK.

The results of the survey compared for example, labour rates, overall profit/subsidy, spend and cost per head and commodity purchase prices. However, the comparisons were only at a very superficial level and not of much use because it was believed that each company managed quite different catering operations and therefore they could not be fairly compared. For example, they considered that commercial catering could not be compared to subsidised staff catering, and that a heavy manufacturing site could not be compared to a finance house staff catering service. Accordingly, this attempt did not in effect get any further than the previously described group of catering controllers.

The larger contract catering companies have internal performance measurement programmes encompassing finance, food and service quality and customer satisfaction. However, these are specific to that organisation and in a highly competitive business do not have the ability to compare themselves with other catering businesses.

In some of the above-described cases, basic comparisons between a company's performance with other like companies has been on the basis of a comparison with a generally distributed predetermined set of averaged data or predetermined benchmark data which is supplied to companies for effecting such comparisons. The difficulty with such data is that it is often very industry specific and as such its compilation takes a considerable amount of time. Accordingly, the data is typically gathered infrequently thereby resulting in comparative data which becomes quickly out of date. For example, the Industrial Society, in conjunction with Delloite Touche, have carried out a Catering Survey periodically for some twenty years now. In the last survey, contact was made with 1500 companies to supply information on a variety of catering outlets, with the data response from about 500 of those companies producing overall statistics, e.g. average spend per head, labour productivity, average selling and cost prices of generally described food products. The publication ofthis survey's latest version was 1996/7.

It is desired to overcome or substantially reduce at least some of the above described problems of the prior art methods.

### SUMMARY OF THE INVENTION

According to one aspect of the present invention there is provided a system for measuring the financial and operational effectiveness of a multi-parameter entity, such as a company, the system comprising: input means for collecting multi-parameter input data in a predetermined questionnaire format describing the operation and function of the entity; wherein the input means is arranged to collect entity generic data for diverse entity comparisons, and entity specific data obtained in a predetermined set of categories for similar entity comparisons; a database of averaged multi-parameter input data comprising averaged entity generic data and averaged entity specific data; and a comparison means arranged to compare the entity generic data with the stored averaged entity generic data to determine the condition of the entity relative to a diverse range of entities, and to compare the entity specific data with the stored averaged entity specific data to determine the condition of the entity relative to a subset of similar entities.

This aspect of the present invention lies in two facts. Firstly that entity generic questions (non-entity specific questions) are asked such that data for comparisons for these parameters with all entities no matter how diverse to the present entity can be made.

Secondly, the present invention simultaneously requires that entity specific questions be asked but in a predetermined set of categories such that similar entity comparisons can be carried out. This duality of this input data in a multi-parameter analysis provides an optimum solution for comparison purposes because it maximises for each parameter the averaged bank of data being considered whilst at the same time enabling a very high resolution of analysis to be carried out.

The present invention enables different industries to be compared because of the types of generic questions asked and also because of the resolution of the entity specific questions asked. Entity generic data can be obtained from questions relating to business turnover for example, whereas entity specific data can be obtained from questions relating to catering products sold, for example.

Preferably the input means is arranged to specify the predetermined set of categories for user selection. Here the user advantageously is provided with what is in effect a multiple choice selection. However in selecting the appropriate category, this enables comparison of the high-resolution specific data between similar entities. More specifically, the businesses products (entity specific data) have to be matched to the specified broad headings as best possible. So the user is forced to map their items onto the predetermined set of categories to enable the previously mentioned high-resolution comparisons to be carried out. This also has the beneficial effect of reducing the number of variables because the categories of products an entity sells, for example, can be set out rather than the entity having to use its own definitions and descriptors which would make comparison very difficult. For example in the catering industry—the input means can specify a list of sandwiches including egg and tomato, whereas the supplier only sells egg, tomato, lettuce and cress. This will result in a range of prices being determined for this item which will compare with the range of ingredients the user has above or below the basic requirement. As a result of this analysis an entity may decide to cut back on its additional ingredients and lower its price as it does not compare favourably with other catering suppliers.

Preferably, the input means may be arranged to group together parameters relating to a category, such as an item and that item's price. The fact is that in a multi-parameter entity, one parameter is often dependent on the value of another. In this case, the present invention can group together different parameters to analyse the group effects.

The database preferably comprises a dynamically changing database comprising averaged multi-parameter input data previously obtained from other entities via the input means. This enables the most up-to-date information to be used for the comparison rather than averaged data which has been obtained at a given moment in time. Also as the database grows, the value of the comparison becomes greater and more valid.

The system may further comprise update means for using the received multi-parameter input data to update the stored averaged data each time new input data relating to an entity has been received. This provides a way of providing the most up-to-date database for comparison purposes.

The present invention also extends to a tendering process incorporating the above described system which enables the performance of a company's contract tenders to be assessed in relation to the tenders of other companies. Here the input mechanism means requires questions relating to the company's tendering process to be answered. Also this enables the tendering process for several companies to be regulated thereby enabling a like-for-like comparisons of their respective processes to be made.

Another aspect of the present invention resides in the appreciation that any multiparameter entity analysis comparison should be with a dynamically changing database of averaged multi-parameter information rather than a static database of industrial norms information. The dynamic nature of the database can be changed on each enquiry for a check on the condition of the entity as the information gathered is not only used to determine the comparative ‘health’ of the entity but also is added to the database to define the dynamic normals for the next entity's he@lthCHECK.

More specifically, according to another aspect of the present invention there is provided A system for measuring the fmancial and operational effectiveness of a multi-parameter entity, such as a company, the system comprising: input means for collecting multi-parameter input data in a predetermined questionnaire format describing the operation and specification of the entity; a dynamically changing database of averaged multi-parameter input data previously obtained from other entities via the input means; and a comparison means for comparing the multi-parameter input data with the stored averaged data to determine the relative condition of the entity.

As mentioned previously, the major advantage of using such a dynamically changing database is that the averaged data provided therein for the purposes of comparisons is the far more up-to-date that is available through the prior art. Also because the database is not restricted to any specific area of activity for an entity, in other words it preferably contains data from diverse entities, comparisons are now possible with entities which are not in the same area of activity. This has a significant benefit for companies, for example, to assess their performance in a global context rather than just in an industry specific way which has been the prior practice.

When starting the process of analysis, there is not enough information in the dynamically changing database to provide statistically significant results. Accordingly, in this case for a short period of time, the predefined industry norms are used. These are preferably provided in a industry norms database which the system can access. They are however, replaced preferably on a parameter by parameter basis when a statistically significant number of entries have been input into the dynamic database. This is preferably done on a parameter by parameter (field by field) basis as some input data will not have answers to particular fields (namely some fields will not be applicable to a given industry).

At present 400 results are used to generate industry norms and so when the number of input data results for a given field exceeds this, switching means of the system can switch to the. input data rather than the predefined norm data. Accordingly, the switch can be made when the input data exceeds the number of respondents asked to generate the static predefined norms data.

The present invention also extends to a method of measuring the financial and operational effectiveness of a multi-parameter entity, such as a company, the method comprising: collecting multi-parameter input data in a predetermined questionnaire format describing the operation and specification of the entity; maintaining a dynamically changing database of averaged multi-parameter input data previously obtained from other entities; and comparing the multi-parameter input data with the stored averaged data to determine the relative condition of the entity.

The present invention enables an assessment of the entity to be made from which informed decisions can be made. Also the ability to frrther interrogate the database on a number of intervals and levels for report generation is provided. The nature of the questions, the detail and format of the data capture and the storage and retrieval of information all provide advantages to the implementation of the present invention.

An embodiment of the present invention, herein after referred to as he@lthCHECK, is now briefly discussed.

he@lthCHECK is an interactive computerized analysis system for measuring the financial and operational effectiveness of a company. The system stores industrial norms and benchmarks financial and procedural activity. he@lthCHECK collates responses from customers to produce an industry database, which enables users of the system to compare their performance against the database and or against segments of the database. This is achieved by:

A financial and operational blue print of a company's performance is entered into the program.

The submitted information is verified and checked against budgets and or previously submitted performance.

All the information submitted is stored within a central database, which is accessed from the web.

Reports are generated giving a snapshot view of company effectiveness against previously stored Industrial norms and Benchmarks.

The database enables companies to measure their performance against each other and against their own internal sites.

The database uses information from within its knowledge base (database) to produce its own industrial norms and benchmarks.

he@lthCHECK is not a system designed to sit on individual machines. However, an application does reside on individual PC's allowing the user of the system to complete a he@lthCHECK remotely (off the web) and, when ready, to update the server with their information. Users of the system may enter information directly on the website or use the local application and update the system when complete.

Because the system is accessed from the web it enables organizations the opportunity of comparing not only their own performance against industrial norms and benchmarks but of accessing the database to compare themselves against other companies within the database.

As the database grows the benchmarks and performance indicators are taken directly from within the knowledge base so enabling up to date and day-by-day comparisons. The purpose of the system is to enable an organisation for example to see if it is healthy or sick and to highlight those areas that require attention. From a purchasing perspective this may be on a daily or weekly basis, from a sales and distribution stand this may be longer, depending on the industry. The term healthy or sick is relative to which facet of the database program a company is accessing information from. For instance, a company may be internally healthy against their own budgets but sick in comparison to other companies in this sector by comparison.

Comparisons may be made to the industry at large or sections of the industry based upon user defined criteria. In this way geographic location or plant size may be matched to gain further understanding of operational effectiveness and profitability. Moreover, the company may also compare individual performances after a given period of time, since their last he@lthCBECK, or set this information against the total outlets within a group of companies.

he@lthCHECK is not a stand-alone program covering all aspects of a business there is need to drilldown to specific disciplines and industries in order to reflect the actual environment being monitored. This means that a completely different he@lthCBECK is designed for particular applications. For instance Health & Safety is governed by the policies implemented by law and a companies adherence to them.

1. Changes in the law will affect both the policies and procedures that a company is required to implement.

he@lthCHECK requires updating with information as defined by the marketplace to remain current.

2. A company could have all the policies and procedure in place but fail to exercise them on a regular basis.

he@lthCHECK is capable of reporting on the procedural compliance of a company to the law and its adherence to its obligations.

3. The company could also not have all the policies in place to comply with their legal obligations.

he@lthCHECK is able to identify the specific obligations that any industry has. The formats of the answers given are required to be tutorial in essence, and tell a company what its obligations are.

All information gathered by he@lthCHECK on a company is combined within the same database, though not necessarily the same tables, to allow the system to obtain a complete overall view of a company.

### BRIEF DESCRIPTION OF THE DRAWINGS

In the drawings:

FIG. 1 is a schematic system diagram showing a communications system and an analysis system embodying the present invention which is connected to the communications system;

FIG. 2 is a schematic block diagram showing the analysis system of FIG. 1 in detail;

FIG. 3 is a schematic block diagram showing the different types of data structures present in the permanent storage of the system shown in the system of FIG. 1;

FIG. 4 is a flow diagram showing a method by which the analysis system of FIGS. 1 and 2 is used to provide the results of an analysis to a user.

FIG. 5 is a flow diagram showing in detail how the step of generating calculation data as shown in FIG. 3 is carried out; and

FIG. 6 is a flow diagram showing in detail how the steps of carrying out benchmarking comparisons and generating a report as shown in FIG. 3 are carried out.

### DETAILED DESCRIPTION OF PRESENTLY PREFERRED EMBODIMENTS OF THE PRESENT INVENTION

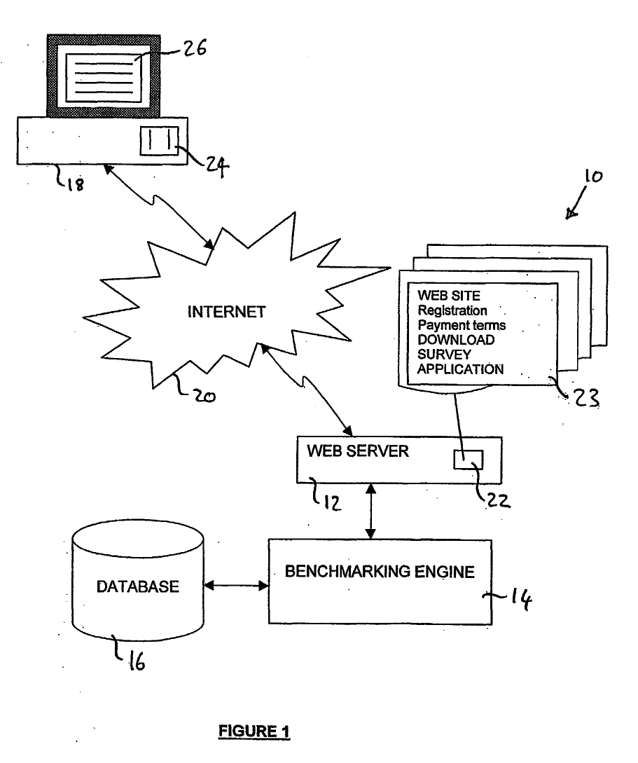

An analysis system according to a preferred embodiment of the present invention is now described with reference to FIG. 1. The analysis system 10 (hel@thCHECK) comprises a Web server 12 a benchmarking engine 14 and a permanent storage 16.

The Web server 12 provides wide area network communications from the benchmarking engine 14 and the permanent storage 16 to a user's computer 18 via the Internet 20. In this way, the user can connect to an analysis system Web site 22 (with its associated web pages 23) hosted on the server 12 and can obtain the relevant questionnaire program 24 which is downloaded to the user's computer 18 for generating a questionnaire 26. The questionnaire program 24, which is in effect a client application, generates the questionnaire 26 offline such that detailed information about the user's company can be obtained for analysis.

The benchmarking engine 14 which provides the detailed questionnaire 26 to the user, as has been mentioned above, also performs analysis of that questionnaire 26 to determine the ‘healthiness’ of the company which the user has provided information about. This analysis can be considered to be carried out by a server application. In doing this analysis, the benchmarking engine 14 makes use of the permanent storage 16 which stores all relevant data, averaged data and analysis rules required. Subsequently, the results of the analysis are put together in a report (not shown) and transmitted to the user's computer 18 for consideration.

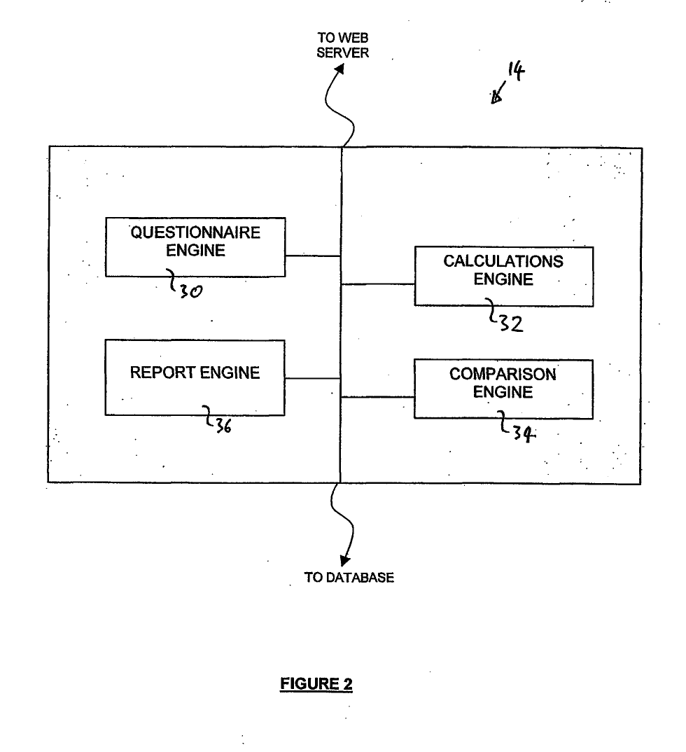

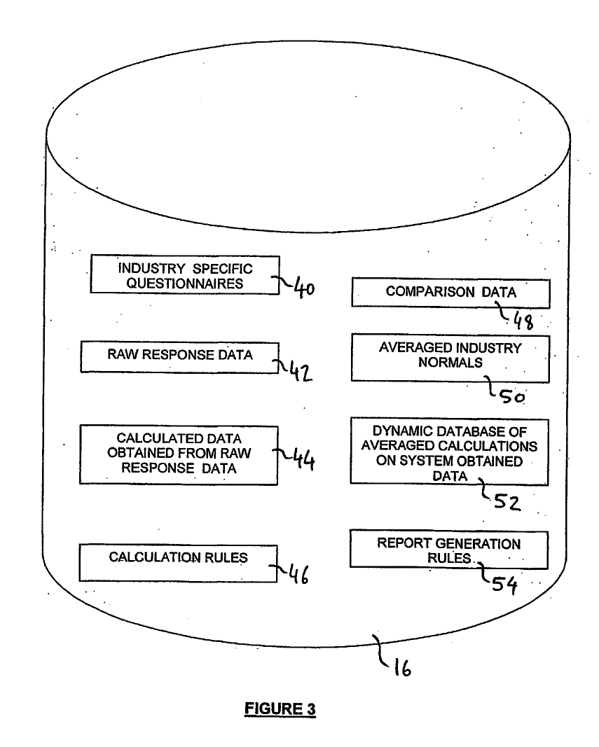

The specific constructions of the benchmarking engine 14 and the permanent storage 16 are now described in greater detail, with reference to FIGS. 2 and 3 respectively. As can be seen from FIG. 2, the benchmarking engine 14 comprises four software modules for carrying out the analysis, namely a questionnaire engine 30, a calculations engine 32, a comparison engine 34 and a report engine 36. Each of these engines is linked to the server 12 and the permanent storage 16.

FIG. 3 shows the information stored within the permanent storage 16. This information comprises industry specific questionnaires 40, which are each detailed questionnaires 26 targeted towards a particular industry. The responses to the questionnaires 26, hereinafter termed raw response data 42, are also stored as is the calculated data 44 calculated from the raw response data 42 in accordance with a set of calculation rules 46. The calculation rules 46 are also used to generate comparison data 48 from the calculated data 44 which has been previously determined.

The permanent storage 16 also stores for comparison purposes two types of averaged data. The first type is industry averaged norms 50 on calculations. This averaged data 50 is compiled in a conventional manner and is available from commercial published sources. The second type is a dynamically changing database 52 of averaged calculations on raw response data 42, namely averaged information which has only been obtained from answers to questionnaires 26 generated by the analysis system 10. Finally, the permanent storage 16 comprises a set of report generation rules 54 which are required to select parameters of the comparison data 48 which have been compared with averaged data 50 or the dynamically changing database 52 for generating specific reports.

The way in which each of the software modules of the benchmarling engine 14 is operated is briefly described below.

The questionnaire engine 30 is provided for generating an appropriate questionnaire 26 for the user and thereafter verifying the questionnaire responses received. The questionnaire engine 30 also stores the verified data in the permanent storage 16 as the raw response data 42.

The calculations engine 32 uses the calculation rules 46 to generate calculated data 44 from the received raw response data 42 and stores this in the permanent storage 16. The comparison engine 34, when requested, carries out some further calculations based on the calculation rules 46 to generate the comparison data 48 from the calculated data 44 alone. This is then stored in the permanent storage 16 for comparison purposes.

The comparison engine 34 then determines whether it is appropriate to compare an item of comparison data 48 with either the averaged calculations in the dynamically changing database 52 or the industry averaged data 50 stored in the permanent storage 16. Having decided which one to make the comparison with, the comparison is made.

The last software module of the benchmarking engine 14 is the report engine 36 which is provided for collating the results of the comparison engine 34 as there are usually many different parameters to be considered. The report engine 36 sends a report of the comparison onto the user for consideration.

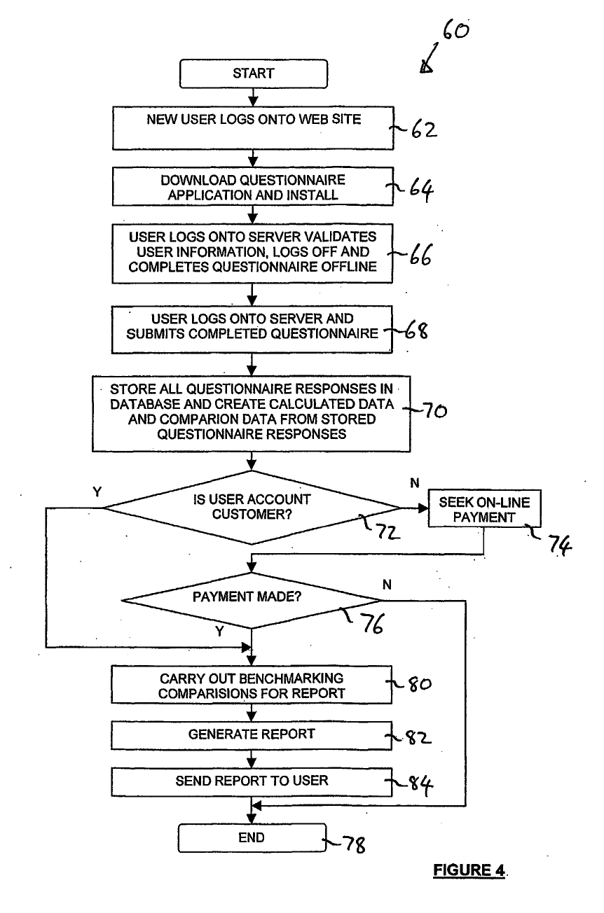

Referring now to FIG. 4, a method 60 of interacting with the analysis system 10 (he@lthCHECK) is now described. The method commences with a user logging on at Step 62 to the analysis Web site 22 hosted by the web server 12. Here the user specifies which area of business his company operates in and then he selects the option of an offline he@lthCHECK analysis for that company. On receiving a request for such an analysis from a user, the Questionnaire engine 30 determines the type of questionnaire 26 to be sent to the user. As the request stipulates the area of the business which the user's company operates in, for example catering, the questionnaire engine 30 can retrieve a pre-stored questionnaire 26 relating to the catering sector from the set of industry questionnaires 40 stored in the permanent storage 16.

The selected questionnaire 26 is sent to the Web server 12, for delivery to the user over the Internet 20. As mentioned previously, as the questionnaire takes a long time to complete, it is sent (downloaded) at Step 64 to the user together with the application program 24 which enables it to be completed off-line (in a so called briefcase model). On downloading the application program and the questionnaire 26, the user installs au Step 64 the application program 24 on their computer 18 such that the questionnaire 26 can be presented to the user for completion in their own time. The application program 24 contains a local subset of the data on the analysis system 10 which enables the questionnaire to be presented correctly.

The questionnaire 26 is in two parts, a Survey section and a he@lthCHECK section. The Survey section asks background questions about the company's operations, covering employees, facilities, payment methods, etc. The user answers questions by checking boxes corresponding to the answers on the form, entering responses into a textbox, or by entering information directly into a grid. The survey section typically comprises seven tabbed pages.

The he@lthCHECK section inquires about costs and sales namely, about company budgets, products used, staff hours and benefits, etc. After entering a Budget End date, the number of weeks left in the budget is calculated automatically. If a grid is supplied for a question, a database navigator component is enabled in the application program 24 which the user clicks on the grid to assist in its completion.

The he@lthCHECK section typically consists of twenty-three tabbed pages. Similar to the Survey section, the user answers questions by checking boxes corresponding to the answers on the form, entering responses into a textbox, or by entering information directly into a grid. For most of the he@lthCHECK section pages, the user is able to select items from a lookup list and supply information (if the user is in the catering industry) such as: portion size, tariff price and unit cost. Both the Survey section and the he@lthCHECK section are described in greater detail later with reference to Tables A to K and User Selection List 1 for the Survey Section, and Tables L to X and the User Selection Lists 2 to 5 for the he@lthCHECK section.

Prior to completion of the Questionnaire 26, the user logs on at Step 66 to the Web site 22 and at a selected Web page 23 the user validates his information, namely name address etc. At this stage the user can become an account holder for billing purposes.

The user is able to save information locally for incomplete forms and return later to complete them. Upon completion of the questionnaire 26, at Step 66, the user clicks on a Submit button in the client application 24, a secure Internet connection is established with the Web server 12 and the response data is submitted at Step 68 to the analysis system 10. The Web server 12 authenticates the user and validates the transmitted data. Once the information is transmitted to the server, any user possessing the appropriate access codes can view the information, subject to having made the appropriate payment or having at least set up an account (described later).

Once the completed questionnaire 26 is returned, the questionnaire engine 30 carries out verification and checking of the questionnaire response data. Then the checked data is stored at Step 70 on the permanent storage 16 as raw response data 42. Also at this time, the calculations engine 32 creates the calculated data 44 from the raw response data 42 and stores them in the permanent storage 16.

The submission of data inherently means that a request from the user for a report has been received. The method 60 continues to determine at Step 72 whether the user is a user account customer. If the user is not an account holder, the user is taken at Step 74 to a web page 23 for obtaining that payment. Then a check at Step 76 is made to determine whether the payment has been made. If there has been no payment of the requisite fees for the report then the method 60 ends at Step 78 with the user being taken back to a home page 23 of the Web site without receiving the report. However, if payment has been made, then the method 60 continues in the same manner as if at Step 72 the user was an account customer.

Accordingly, the method 60 continues with the carrying out at Step 80 of benchmarling comparisons. Once these have been completed, a report is generated at Step 82 and the report is then forwarded at Step 84 to the user. This then ends at Step 78 the method with the user being returned to the home page 23 of the Web site 22.

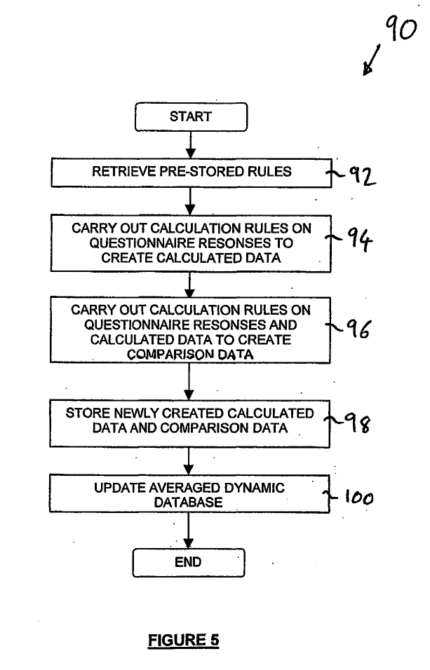

Referring now to FIG. 5, a sub procedure 90 (at step 70 of the method 60) of creating the calculated data 44 and the comparison data 48 from the raw response data 42. is described in greater detail. The sub procedure 90 commences with the calculations engine 32 retrieving the pre-stored calculation rules 46 from the permanent storage 16 at Step 92. These rules 46 specify how the raw response data 42 is to be combined logically to create certain ratios and new parameters which are useful in future analysis of the data.

The retrieved rules 46 are then applied to the raw response data 42 to derive at Step 94 the calculated data 44. The rules 46 are also used at Step 96 to obtain the comparison data 48. However in this instance, both the raw response data 42 and the newly created calculated data 44 are used to derive the comparison data 48. The comparison data is directly comparable with stored parameters in both the averaged industry norms 50 and the dynamic database 52 of averaged calculations on system obtained data. The creation of the comparison data 48 is seen in detail in Tables Y to AA of the accompanying Annex.

Subsequently both the newly created calculated data 44 and the comparison data 48 are stored at Step 98 in the permanent storage 16. Also the dynamic database 52 of averaged calculations on system obtained data is also updated at Step 100 with the comparison data 40. The updating takes the form of recalculating a new average for each field in the database using the new data in combination with the existing data. This has the effect of making the dynamic database 52 update its content on every receipt of a questionnaire 26 thereby making it the most up-to-date comparative measure of the industry not only in the user's company's business area but also across the entire spectrum of business as will be explained later.

When updating the dynamic database of comparative data 52, for each field in that database, a counter (not shown) is run of how many results have been used to-form the average value stored in the dynamic database 52. This counter is used in deciding whether there is enough information for a given parameter to effect a statistically significant comparison with current comparative data 48 as will be described later.

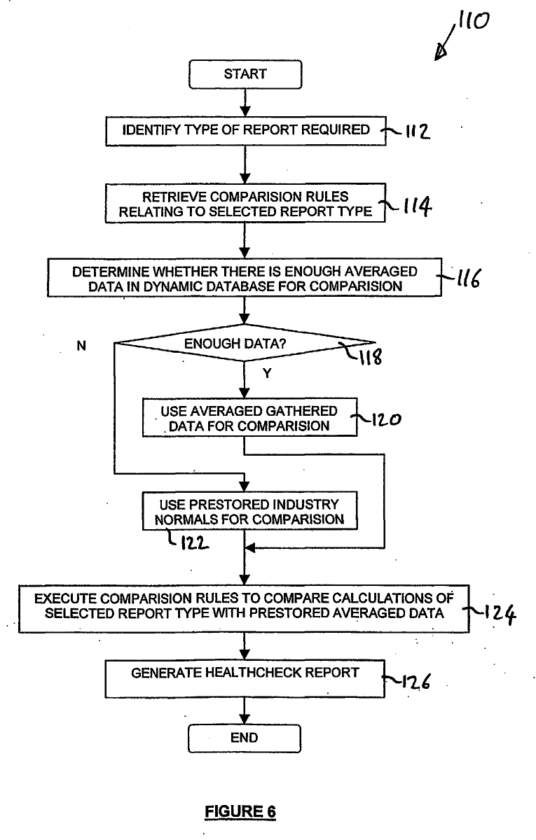

Referring now to FIG. 6, a sub procedure 110 (at step 78 of the method 60) of carrying out benchmarking comparisons for the he@lthCHECK report is described in greater detail. The sub procedure 110 commences with the comparison engine 34 determining at Step 112 the type of report required by the analysis engine. For example, the user may require a full in-depth he@lthCBECK report or may wish only to have a brief overview report. This in turn determines the number and type of comparisons that are required for generating the he@lthCHECK analysis report.

The comparison rules 46 which are appropriate to creating the selected report type are then retrieved at 114 from the permanent storage 16. Then it is desired to execute these comparison rules 46 on the comparison engine 34. However, before this can be done, the averaged data set against which the comparison is to be made is determined. The comparison engine 34 determines at Step 116 whether there is enough averaged data in the dynamic database 52 for each given parameter that is to be assessed for the comparison to be made with the data of the dynamic database 52. More specifically, this is determined by the comparison engine 34 checking the value of the counter for each stored parameter. If the counter is over some predetermined value then the check at Step 118 is positive. Otherwise the check at Step 118 is negative. Typically, the predetermined value is set to be at the number of responses used to create the pre-stored static industrial norms 50. In the present embodiment, the industrial norm data is made up from 400 responses and so the predetermined value is 400. However, this value may be adjusted by the analysis operator to be lower to reflect the more up-to-date nature of the dynamic database information, if considered to be more appropriate. This is particularly the case when the area of business is a rapidly changing one and the industrial norms data 50 is relatively old and therefore possibly much less relevant than it used to be.

If there is enough data in the dynamic database 52 for the comparison, which is clearly preferable, the data from the dynamic database is selected at Step 120 for use. Otherwise, the data of the pre-stored industrial norms 50 is selected at Step 122 for the comparison. The comparison engine 34 is intelligent enough to make this selection on a parameter by parametersbasis, namely a given comparison may well have some parameters which are compared with the data from the pre-stored industrial norms 50 and other parameters which are compared with the data from the dynnmic database 52.

Then, at Step 124, the comparison data 48 of the present questionnaire obtained from the calculations of the selected report type is compared with the selected pre-stored averaged data This again is carried out on a parameter-by-parameter basis. The comparison can generate comparison results in many different areas of the user's business. However, only the selected areas are processed and a used to generate at Step 126 the he@lthCHECK report.

Returning now to the questionnaire 26 which is sent to the user, the he@lthCHECK section has the following structure:

Under the Survey section:

Company Budget

Information of the budget is entered into the system and typically a check will be made on the previous six months sales.

Staff

The labour and management structure to run an organization is ascertained. This section also deals with the remuneration package that individuals benefit from working.

Business Charges

This section deals with all rentals leases and charges for maintenance contracts.

Management Fee

This section enables those companies that are hiring their services out to enter in any charges they may make against the contract.

Client Issues

This section enables any services that are provided to the client on a cost basis to be entered. This section is mainly specific to the industrial catering sector.

Under the he@lthCHECK section:

Questionnaire Cost & Sales Analysis

This section enables the structure and manning of production to be assigned to a time frarne. It also allows for the type of products sold to be entered into the database.

Cost & Sales Analysis

The structure of all sales by method of distribution. The volumes of individual items are gathered, selling prices, and cost prices.

Sundry Items

All other items of expenditure, postage etc.

The Survey section of the questionnaire, which has the purpose of looking at the company background and asking for other additional information, is arranged to ask questions in the following areas:

The structure and organizational functions of the business.

The specific contracted services that a company is buying in or subcontracting.

The total area of the site broken down into production units.

The method of payments that are used in selling their goods

Any changes to the services or goods supplied.

Any changes to the management structure.

The marketing techniques used and the effect that this has had on sales.

The types and number of distribution outlets and the volume of sales through specific outlets.

The benefits supplied to the employee by their staff categories.

The above embodiment is now flirdier explained with reference to an exemplary application in the complex catering industry. However, it is to be appreciated that the present invention is not restricted to this field and can readily be applied to any area of business or service which is susceptible to analysis, for example education, healthcare, construction, retail outlets and other areas having organisations, the operation of which can be analysed.

The example is set out in the Annex which lists a set of Tables from Table A to Table AA and User Selection Lists 1 to 5. More specifically, Tables A to K and User Selection List 1 represent the Survey section, Tables L to X and the User Selection Lists 2 to 5 represent the he@lthCHECK section and Tables Y to AA represent the comparison data 48 derived from the raw questionnaire response data 42 and the calculated data 44.

Each of the Tables sets out the corresponding set of calculations rules 46 used to create the calculated data 44 or comparison data 48. The User Selection lists provide predetermined categories of answer which the user is required to select for an input. For example in Table E, the set of questions is for a selected type of employee and the type is selected from List 1. Also in tables N,O,P, and Q, the list of items for which the data needs to be entered is set out in Lists 2 to 5 respectively. Although not shown, similar lists are provided for Tables R to X. In each of these cases, the user selects the items from the list and provides the required details as set out in the table per item.

The Cost & Sales Analysis of Tables N to Q is broken up into four sections: HOT, COLD, BEVERAGES & CONFECTIONERY. This enables the analysis system 10 to look at the fundamental differences within the service. No effort is made to look at what a particular site calls their service units as this would mean that it would not be possible to compare like for like. An example, of this would be seen in a motor industry comparison where instead of looking at models of cars, the analysis system 10 would looks at the size of the engine.

Having entered all the details of their catering business in the Survey and he@lthCHECK sections of the questionnaire 26, the calculations engine 32 carries out all of the required calculation rules to generate the required calculated data 44 and comparison data 48 from the raw response data 42 for a given type of report. The comparison data 48 is then used by the comparison engine 34 to generate desired comparisons which are selectively compiled by the report engine 36 into the desired he@lthCHECK report.

The he@lthCHECK report can produce the following types of comparison results which help to understand how well a company is doing. The types of comparison results can be grouped differently to represent more or less detailed reports for the user. The following comparison results and comparison data are provided:

Comparison of Business to Business

Comparison of actual trading as measured by analysis to budgeted trading

Subsidy per Employee/Student/Customer

Profit Contribution by Employee/Student/Customer

Average site usage of Catering Service

Relationship of main meals to snack meals

Spend per head

Cost per head

Gross Profit

Number of products sold

Number of products consumed

Number of customers served

Weekly sales to customers

Daily sales by customer

Weekly sales by customer

Number of catering staff employed.

Number of full and part time staff employed

Number of Full Time Equivalent catering staff

Value of sales by each staff member

Labour efficiency to customers served.

Banded annual salaries by job title

Banded annual salaries by location

Banded hourly rate of pay by job title

Banded hourly rate of pay by location

Pension rates by job title

Pensionable employees in relation to the whole staff compliment

Rates of pay below the minimum wage

Space allocated to catering

Revenue per square metre

Cost per square metre

Revenue per seat

Cost per seat

Cost of Utilities per square metre

Rental cost of vending machines by type

Length of lease/rental

The comparison results can also be spread in different ways to show how specific sectors are performing comparatively and the progression of the company or any of its sectors:

Across Whole Industry

By Site Location

By Region

By Group

Specific Industries

By size of Workforce/Student Population/Customer foot fall

By style of service

By service times

By product

Category, hot food, cold food, beverages, confectionery.

Individual products

Generically described products

Non food products

The way in which the company is performing over time in each of its sectors can also be determined by the following breakdowns (here data entered for a short time period such as a week can be extrapolated to yearly projections if required):

Introduction of new services

Introduction of new products

Changes to services

Changes to products served

Increase or decrease in catering uptake

Pricing Policy

Changes in style of contract

Contractor remuneration

Effects of Marketing

Contract life

Number of contracts due for renewal in a time period

Reason for changing contractor

Change from In House to Contract

Change from In House to DSO (Direct Service Organisation)

Change from Contract to In House

Change from Contract to DSO

Change from DSO to Contract

Change from DSO to In House

Number of Catering outlets:

self operated

Contracted out

DSO

Other

Number of respondents with or without a catering policy

Increase or decease in customer spend

Amount of holiday entitlement

Amount of sick days entitlement

Number of employees pension entitlement

Space allocated to catering

Different ones of the above mentioned comparison results and comparison data are selected for different types of reports. The level of detail of each report can also be determined by the selection such that generic entity comparisons (with non-catering companies for example) can be carried out by looking largely at the results derived from the Survey section information and specific entity comparisons (with the detailed specifics of catering companies for example) can be carried out by looking largely at the results derived from the he@lthCHECK section information.

According to another embodiment of the present invention there is provided a Tender Process system (not shown) that enables companies to take services out to contract or to re-tender contracted services. The Tender Process system utilises the above-described analysis system 10. The information regarding the tender may be obtained from the companies tendering for a particular contract using a questionnaire 26 in the same manner as described before. However, it is also possible for the company putting the contract out to tender to enter into the system the criteria for companies to tender against.

The Tender Process system ensures that all the companies tendering for contracts are doing so on a like for like basis based within the tender process. The program is user-defined time sensitive to ensure that completion is within the limits of the individual tender. All the submitted tenders are stored in a central database for reference irrespective of success or failure. In this way, advantageously an audit trail of companies success or failure may be given and accessed to enable them to improve performance. Also a body of averaged tendering data can be built up such that companies can have a look at averaged parameters for successful tenders as well as averages for unsuccessful tenders.

The Tender Process system using the analysis system 10 of the previous embodiment is new. The system enables companies to compare quickly tendered facilities. By using the facilities of the analysis system 10 described above, the Tender Process system enables the company or body to monitor the progression of the contract against their original tender. It may also allow the reports to be generated on the effectiveness of the contractor on all sites where a he@lthCHECK analysis has been performed against the original tender or any tender.

In an alternative embodiment, rather than particular ones of the comparison rules being selected for generating the he@lthCHECK report, all of the rules are selected and executed. It is only when the report is being generated that selected results of the comparison are used in dependence on the type of report required. This has the beneficial effect of reducing the complexity of the comparison process.

Having described particular preferred embodiments of the present invention, it is to be appreciated that the embodiments in question are exemplary only and that variations and modifications such as will occur to those possessed of the appropriate knowledge and skills may be made without departure from the spirit and scope of the invention as set forth in the appended claims. For example whilst an off-line questionnaire has been described there is no reason why, if the user required, the questionnaire could not be provided as an on-line questionnaire. This would have the benefit of not requiring a client application 24 to be run on the user's computer may be more expansive to complete due to the cost of maintaining the Internet connection.

The questionnaire 26 may also contain a section of questions relating to a Shopping Basket. This section would deal with those items that are bought in by a company. These are the raw materials that a company will produce its products from. A comparison of costs can typically be made in this section to ascertain the purchasing might of a company or operation.

Furthermore, it is to be appreciated that the questionnaire 26 may have a dynamic nature in itself. Because a questionnaire program 24 is provided on the client's computer 18, the questionnaire 26 (both the survey section and the he@lthCHECK section) can be responsive to user input to create new pages and questions which are required. This extends to the feature of replication, namely the subdivision of a given business unit into sub-units for analysis to be carried out on each sub unit as well as the business unit as a whole. For example, where a catering organisation has a cafeteria and a restaurant, in the same building, many of the resources may be shared between these entities and they may be run under one budget. However, analysis of the performance of each may be required separately by benchmarking comparisons to other separate cafeterias and restaurants or even separate retail outlets. In this case, the questionnaire program 24 whilst the questionnaire 26 was being completed, would recognise that there were two entities to be analysed and would replicate a set of new questionnaire pages for obtaining specific details about the second entity. The replication would only reproduce those pages which required separate new information to be added with the common responses suitable for both entities not requiring additional pages. Subsequently a benchmarking report would be generated for each entity advantageously to enable a higher resolution of performance analysis to be carried out.

[image]

[image]

[image]

[image]

[image]

[image]

[image]

[image]

[image]

[image]

[image]

[image]

[image]

[image]

[image]

[image]

Claims:

1. A system for measuring the financial and operational effectiveness of a multi-parameter entity, such as a company, the system comprising:
input means for collecting multi-parameter input data in a predetermined questionnaire format describing the operation and specification of the entity;
a dynamically changing database of averaged multi-parameter input data previously obtained from other entities via the input means; and
a comparison means for comparing the multi-parameter input data with the stored averaged data to determine the relative condition of the entity.

2. A system according to claim 1, further comprises update means for using the received multi-parameter input data to update the stored averaged data each time new input data relating to an entity has been received.

3. A system according to claim 2, wherein the update means is arranged to generate comparison data from the input data by performing calculations on the input data using a set of stored calculation rules.

4. A system according to claim 2 or 3, wherein the update means is arranged to calculate new averaged data from a combination of the existing averaged data in the dynamic database and the newly generated comparison data.

5. A system according to any preceding claim, further comprising a static multi-parameter industry norms database and the comparison means is arranged to determine whether the input data, or data derived therefrom, is to be compared to data in the industry norms database or data in the dynamically changing database.

6. A system according to claim 5, further comprising a counter for storing the number of input data entries which make up the averaged data in the dynamically changing database and switching means for switching from the static industry norms database to the dynamic averaged input database when the counter represents a value greater than a predetermined value.

7. A system according to claim 6, wherein the predetermined value is arranged to be set by a user.

8. A system according to any preceding claim, wherein the comparison means is arranged to carry out the comparison individually on selected different parameters of the input data.

9. A system according to claim 8 as dependent on claim 6 or 7, wherein the switching means is arranged to carry out the switching on a parameter by parameter basis.

10. A system according to any preceding claim, further comprising a report generation means for generating a report of the results of a comparison between the multi-parameter input data, or data derived therefrom, with the stored averaged data thereby determining the relative condition of the entity, and for transmitting the report to a user.

11. A system according to claim 10, wherein the report generation means is arranged to be operated in accordance with a set of pre-stored report generation rules specifying the parameters to be compared in order to generate a required user-specified type of report.

12. A system according to any preceding claim, further comprising questionnaire generation means arranged to select one of a plurality of stored activity-specific questionnaires on the basis of a specific area of user-specified activity of an entity, and to transmit the selected questionnaire to the user for completion.

13. A system according to any preceding claim, wherein the entity is a tender for a specified task and the system is arranged to analyse the tender against a predefined multi-parameter set of stored requirements for the task.

14. A system according to claim 13, wherein the comparison means is arranged to compare the tender against stored averaged multi-parameter data regarding previous tenders.

15. A system according to claim 14, wherein the comparison means is arranged to compare the tender against stored averaged multi-parameter data regarding successful tenders.

16. A method of measuring the financial and operational effectiveness of a multi-parameter entity, such as a company, the method comprising:
collecting multi-parameter input data in a predetermined questionnaire format describing the operation and specification of the entity;
maintaining a dynamically changing database of averaged multi-parameter input data previously obtained from other entities; and
comparing the multi-parameter input data with the stored averaged data to determine the relative condition of the entity.

17. A method according to claim 16, further comprises updating the stored averaged data, using the received multi-parameter input data, each time new input data relating to an entity has been received.

18. A method according to claim 17, wherein the updating step comprises generating comparison data from the input data by performing calculations on the input data using a set of stored calculation rules.

19. A method according to claim 17 or 18, wherein the updating step comprises calculating new averaged data from a combination of the existing averaged data in the dynamic database and the newly generated comparison data.

20. A method according to any of claims 16 to 19, wherein the comparing step comprises determining whether the input data, or data derived therefrom, is to be compared to data in a static multi-parameter industry norms database or to data in the dynamically changing database.

21. A method according to claim 20, further comprising counting the number of input data entries which make up the averaged data in the dynamically changing database and switching from the static industry norms database to the dynamic averaged input database when the counter represents a value greater than a predetermined value.

22. A method according to claim 21, further comprises enabling user controlled setting of the predetermined value.

23. A method according to any of claims 16 to 22, wherein the comparison step comprises carrying out the comparison individually on selected different parameters of the input data.

24. A method according to claim 23 as dependent from any of claims 21 or 22, wherein the switching step comprises carrying out switching on a parameter by parameter basis.

25. A method according to any of claims 16 to 24, further comprising generating a report of the results of a comparison between the multi-parameter input data, or data derived therefrom, with the stored averaged data thereby determining the relative condition of the entity, and transmitting the report to a user.

26. A method according to claim 25, wherein the step of generating a report comprises operating under a set of pre-stored report generation rules specifying the parameters to be compared in order to generate a required user-specified type of report.

27. A method according to any of claims 16 to 26, ftrther comprising selecting one of a plurality of stored activity-specific questionnaires on the basis of a specific area of user-specified activity of an entity, and transmitting the selected questionnaire to the user for completion.

28. A computer program comprising program instructions for causing a computer to perform the method of any of claims 16 to 27.

29. A computer program according to claim 28, embodied on a recording medium.

30. A computer program according to claim 28, carried on an electrical carrier signal.

31. A system for measuring the financial and operational effectiveness of a multi-parameter entity, such as a company, the system comprising:
input means for collecting multi-parameter input data in a predetermined questionnaire format describing the operation and function of the entity; wherein the input means is arranged to collect entity generic data for diverse entity comparisons, and entity specific data obtained in a predetermined set of categories for similar entity comparisons;
a database of averaged multi-parameter input data comprising averaged entity generic data and averaged entity specific data; and
a comparison means arranged to compare the entity generic data with the stored averaged entity generic data to determine the condition of the entity relative to a diverse range of entities, and to compare the entity specific data with the stored averaged entity specific data to determine the condition of the entity relative to a subset of similar entities.

32. A system according to claim 3j, wherein the input means is arranged to specify the predetermined set of categories for user selection.

33. A system according to claim 31 or 32, wherein the input means is arranged to group together parameters relating to a category, such as an item and that item's price.

34. A system according to any of claims 31 to 33, wherein the database comprises a dynamically changing database comprising averaged multi-parameter input data previously obtained from other entities via the input means.

35. A system according to claim 34, further comprising update means for using the received multi-parameter input data to update the stored averaged data each time new input data relating to an entity has been received.
